(19) United States
(12) Patent Application Publication
(10) Pub. No.: US 2022/0369811 A1
(43) Pub. Date: Nov. 24, 2022

(54) DRAWER LID AND METHOD FOR MONITORING A DRAWER INTERIOR

(71) Applicant: Julius Blum GmbH, Hoechst (AT)

(72) Inventor: Daniel BERTSCHI, Gelfingen (CH)

(21) Appl. No.: 17/833,336

(22) Filed: Jun. 6, 2022

Related U.S. Application Data
(63) Continuation of application No. PCT/EP2020/084738, filed on Dec. 4, 2020.

(30) Foreign Application Priority Data
Dec. 9, 2019 (CH) 01567/19

(51) Int. Cl. A47B 88/919; A47B 88/457; F25D 25/02; F25D 17/04

(52) U.S. Cl. CPC A47B 88/919; A47B 88/457; F25D 25/025; F25D 17/045; A47B 2220/0077; F25D 2317/04111; F25D 2317/04131; F25D 2317/043

(57) ABSTRACT

A method for monitoring a drawer interior of a vacuum drawer device when the lid is supported by the drawer airtight and closed, includes: periodic measurement of the relative humidity with a humidity sensor arranged in the path of a dehumidifying channel in the lid or, respectively, the drawer interior; comparison of the measured relative humidity with an upper threshold; and as soon as the measured relative humidity is above the upper threshold, opening the valve and inducting a ventilator arranged in a recess or in the path of a dehumidifying channel in the lid. Fresh air is sucked through an air inlet opening, circulated, and thereafter released again from the dehumidifying channel and the drawer interior communicating therewith, until the relative humidity reaches a lower threshold measured by the humidity sensor. Then the valve is closed, the ventilator is stopped, and the controller switches into the humidity monitoring mode.

### TECHNICAL FIELD

The present invention describes a lid for resting on a drawer of a vacuum drawer device having lifting means, wherein the lid makes it possible to seal a drawer interior to the drawer using suitable means in the lid, wherein the lid and the lifting means are operatively connected with a controller, as well as a method for monitoring a drawer interior of a drawer of a vacuum drawer device while the lid is supported by the drawer in an airtight and closed manner, wherein the lid is operatively connected with a controller and electric evacuation means and/or dehumidifying means which are operated in an automated fashion.

### PRIOR ART

Refrigerators for storing food have some disadvantages, as a lot of electric energy is constantly required to massively cool an interior all the time. Up until now, the inner climate of the refrigerator has received little attention. According to an examination of the Hygiene Council, which has carried out an international study called Hygiene Report 2010, the refrigerator having about 11,400,000 germs per square centimeter is more contaminated than a toilet with about 100 germs per square centimeter. That report 2010 had an enormous response of the media, but except for recommendations to clean the refrigerator more often no noticeable improvements have been made.

In DE 20 2017 006 169 a vacuum drawer device with a drawer and a lid was in general disclosed for the first time, wherein by using a pump a negative pressure could be produced in a drawer interior. The vacuum drawer device comprises a drawer with walls and a drawer interior, wherein the drawer can be operatively connected with a lid and is mounted within a drawer carcass such that it can be linearly moved. Further details regarding the drawer, the lid, possible lifting means and evacuation means are, however, largely left open in DE 20 2017 006 169.

The closest prior art is WO 2019/141574 of the applicant. Food that not necessarily has to be kept cool can be stored in a vacuum drawer device at room temperature, wherein it is refrained from increased using of energy.

The drawer interior pressure is evacuated to a slight negative pressure below the atmospheric pressure which is produced in a controlled manner and maintained. This way, food can be kept being consumable and edible for a longer time in an easy way. The storage in the drawer carcass with a vacuum drawer device requires less energy than a refrigerator, as the reduction of oxygen in the interior is done after a few minutes and after that almost no further electricity is required. A vacuum drawer device can be made without using damaging material as cooling means or thermal insulation. Usage of plastic bags as necessary when performing the familiar vacuum packing with a vacuum apparatus can be reduced significantly but food can still be stored for a longer period without any problems. By using a vacuum drawer device food can be stored in an easier, more environment-friendly and more energy-efficient way. That has a positive effect on the quality of the food and on the health of the consumer. Also, less food would be thrown in the trash and therefore the often criticized “food waste” would be reduced, as the quality of the food can be maintained longer.

The drawer carcass forms the outer casing in which the lid and the drawer are movably mounted in a protected manner. Lifting means and evacuation means that can be electrically operated by a controller are arranged in the lid or the drawer such that the evacuation is possible in a controlled manner when the lid is being put onto the drawer. By way of an air channel, air can be pumped out of the drawer interior. When arranging sensors, the evacuation can be performed in an automated manner and also the ventilation before opening the drawer can be identified and automatically induced by the controller.

In WO 2019/141574 a lid that is as dense as possible and configured in a multi-layered manner is provided, which can be simply mounted onto existing drawers, too. In order to keep the height of the lid small, the lifting means and the evacuation means are preferably integrated in the lid.

Now, experience has shown that food being stored in such vacuum drawer devices partially have high loss of gas due to the slight negative pressure or, respectively, slight vacuum. Due to the water activity that can be assigned to any kind of food, a different amount of humidity/water diffuses from the food to the surface of the food and emerges in the form of liquid or, respectively steam to the surface or, respectively, emerges from said surface. After a few hours, a liquid film is produced on the surface of the food, even if the drawer interior or, respectively, the container interior is being pumped off with the evacuation means in the meantime. On these moist food surfaces, fungus is produced relatively fast or the surfaces tarnish unaesthetically such that permanent storing in such a vacuum drawer device of for example bread or openly stored grain bulk material is spoiled rather faster than when stored in an open bread bin. However, the user's request is to store all kinds of food that do not have to be stored cool in such a vacuum drawer device without having to pre-sort them.

### ILLUSTRATION OF THE INVENTION

The objective of the present invention is to create a lid of a vacuum drawer device, a vacuum drawer device comprising a drawer, lifting means, evacuation means and such a lid as well as a method for monitoring a drawer interior, wherein steaming up of food surfaces is to be largely prevented and the forming of fungus in the food surfaces is inhibited in and automated manner.

This problem is solved with a method for monitoring a drawer interior according to claim 1, a lid according to claim 3 and a vacuum drawer device according to claim 11.

In addition to dehumidifying means that are arranged within the lid, as an option lighting of the drawer interior or, respectively, the container interior with blue visible light is provided such that besides preventing a layer of moisture also mold production through radiation is inhibited.

In this case, evacuation means a slight negative pressure below the atmospheric pressure of 150 mbar or more, thus absolute pressures of less than 850 mbar, which can be produced in the drawer interior or, respectively, in the interior of containers in the drawer.

### SHORT DESCRIPTION OF THE FIGURES

Preferred embodiments of the subject of invention are described in the following in connection with the attached Figures.

FIG. 1 shows a perspective view of a vacuum drawer device in a drawer carcass with the drawer open, while

FIG. 2 shows a schematic partial section through a vacuum drawer device of FIG. 1 in a drawer carcass with a closed drawer or, respectively, vacuum drawer device.

FIG. 3 shows a top view of a lid when arranged on the drawer, wherein the integrated components, recesses and channels are shown.

FIG. 4 shows a perspective view of a controllable valve of the side of the lid directed to the drawer carcass with the lid being indicated by broken lines.

FIG. 5 shows a top view onto the bottom side of the lid which is directed to the drawer carcass having completed sealing means and lighting means.

### DESCRIPTION

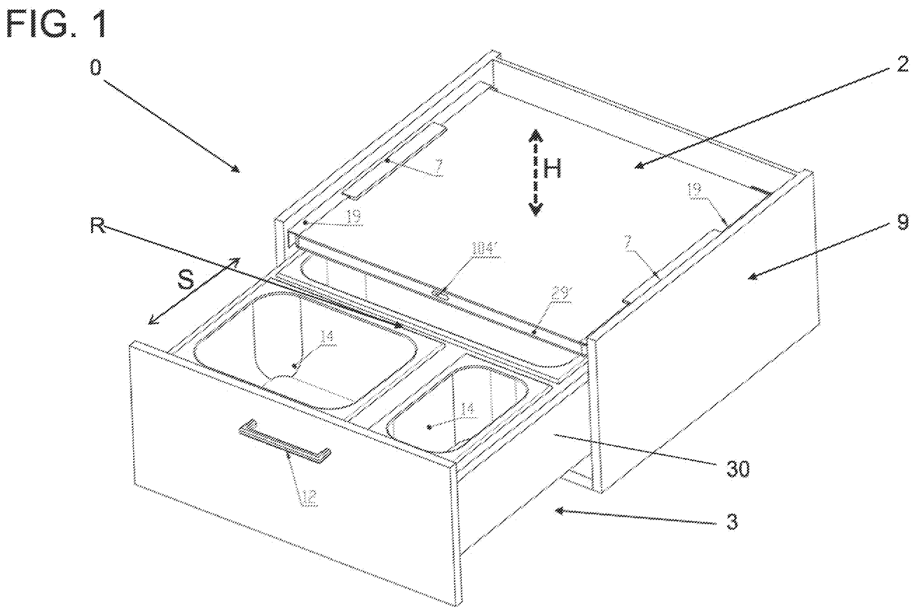

The vacuum drawer device 0 in total is here referred to as 0 and comprises a drawer 3 having a drawer interior R and a lid 2 that can be relatively moved in a lifting direction H by means of lifting means 7. The drawer 3 comprises walls 30 and the drawer interior R and is mounted is such way that it can be moved to be open and closed into the sliding movement direction S and is configured such that it can be evacuated. The drawer 3 can be operatively connected with the lid 2 and is mounted within a drawer carcass 9 such that it can be linearly moved in a sliding movement direction S. The drawer carcass 9 forms the outer casing in which the lid 2 and the drawer 3 are movably mounted in a protective manner. The drawer 3 is mounted in a drawer extension not further described in such way that it can be moved linearly such that the drawer 3 can be brought into an opened and closed position, wherein FIG. 1 shows the opened position of the drawer 3.

The drawer interior R that can be evacuated is formed by a plurality of containers 14, wherein the containers 14 are arranged within the drawer 3 in a positioned manner and each have the same height but different sizes. With the drawer interior R, the interiors of the containers 14 can be evacuated, too. Preferably, the containers are designed as Gastronorm (GN) Containers the interior of which can form the entire drawer interior R which can be closed and evacuated by using the lid 2. The containers 14 are mounted in the drawer 3 and can be moved with the drawer 3, can, however, also be taken out. The containers 14 can, however, also have other shapes and sizes.

The lid 2 which is arranged movably within the drawer carcass 9 serves for evacuation of the drawer interior R, said lid 2 is designed in an airtight manner and mounted in such way that it can be lowered in a lifting direction H perpendicularly to the sliding movement direction S onto the drawer 3. In this case, the lid 2 is fixed with mounting angles 19 at the drawer carcass 9 such that a relative movement of the lid 2 to the drawer 3 is possible.

At and/or partially in the lid 2, within the drawer carcass 9, there are arranged lifting means 7 which keep the lid 2 movable in the lifting direction H within the drawer carcass 9. The design of the lifting means 7 can be done in different ways which, in this case, will not be discussed any further.

With one side of the lid that is directed to the drawer 3, the lid 2 can be put onto the edges of the drawer 3 or the containers 14 by which the at least one drawer interior R can be closed. The lid 2 is movably mounted relative to the drawer carcass 9 and the drawer 3. The lid 2 can be placed on the drawer 3 such that the drawer interior R is sealingly closed. The closing occurs only when the drawer 3 is in the closed position, when the drawer 3 is in the opened position according to FIG. 1, the lid 2 releases the drawer 3 completely. At a handle 12, the drawer 3 can be grabbed and moved into the sliding movement direction S. With an operating button 104′ at the lid 2, the vacuum drawer device 0 can be activated and deactivated. At the lid 2 arranged can be at least one closed-position sensor 29′ which communicates to a controller not shown in FIG. 1 that the lid 2 is closed.

By using the lifting means 7, the lid 2 is arranged in such way that it can be lifted from the drawer 3 or, respectively, the containers 14 in an oppositely controlled manner and also lowered on the same. This way, the lifting movement of the lid 2 in the lifting direction H perpendicularly to the sliding movement direction S of the drawer 3 is created. The containers 14 within the drawer 3 of the vacuum drawer device 0, contrary to conventional drawers, can be entirely closed off against the top by the user manually closing the drawer 3 and the lid 2 lowers itself in the closed position of the drawer 3 onto the containers 14 and closes the same off in an airtight manner.

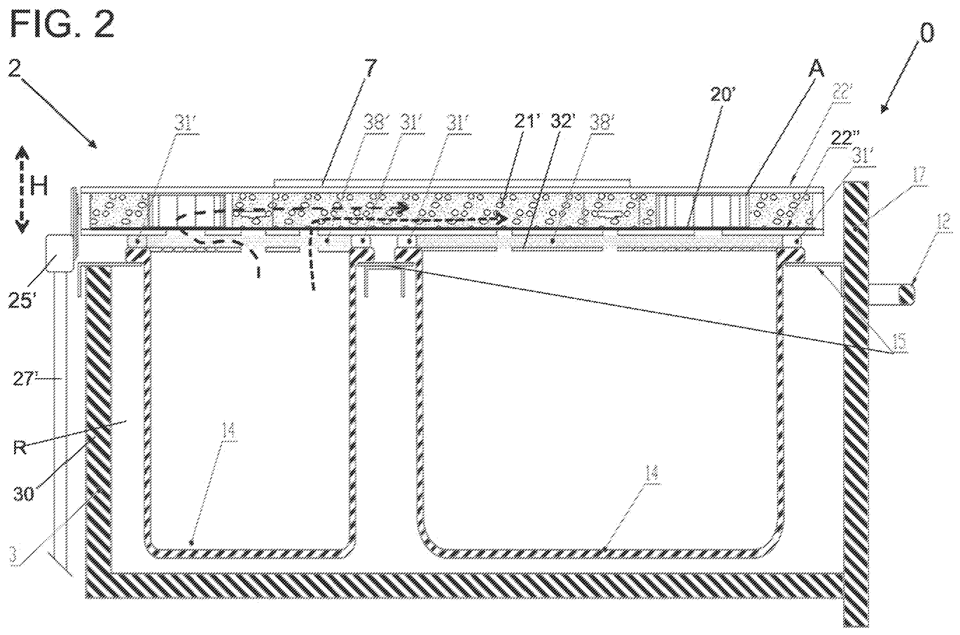

In FIG. 2, the lid 2 that is designed in an airtight manner is shown when resting on the drawer 3 or, respectively, the seal fittings 15. For simplicity, the surrounding drawer carcass 9 has been left out and the drawer 3 is shown in section with an optional front panel 17 as a drawer wall 30 and a handle 12. The lid 2 rests on the drawer interior R or, respectively, the containers 14 closing them off in an airtight manner.

In order to achieve a dense construction method of the lid 2, as many components as possible are integrated in the lid 2.

In addition to the evacuation means, in this case, different channels, sensors and dehumidifying means are arranged within the lid 2 in several recesses A. The different routes of the air when evacuating and when dehumidifying are indicated with broken lines.

An electric cable 27′ is arranged leading to a connecting plug 25′ by means of which the controller is supplied with tension that controls the lifting means, evacuation means, dehumidifying means and sensors. In this case, the controller is also arranged in a recess A in the lid 2, could, however, also be arranged within the drawer carcass 9 separately from the lid 2.

Preferably, the lid 2 has a sandwich construction, wherein different materials in different layers are assembled to one lid 2. The lid 2 has two outer airtight cover layers 22′, 22″ and one core layer 21′. In this case, an additional circuit board 20′ is arranged which, however, can be used also instead of one of the outer airtight cover layers 22′, 22″.

The layers 20′, 21′, 22′, 22″ are statically effective glued to each other to become a multi-layered lid 2 that is executed being correspondingly resistant to torsion. The upper cover layer 22′ is designed in an airtight manner and can consist of MDF, CFRP or glass. However, also an air-impermeable plastic coating on an air-permeable material can be arranged as upper cover layer 22′ in order to achieve the airtightness of the upper cover layer 22′.

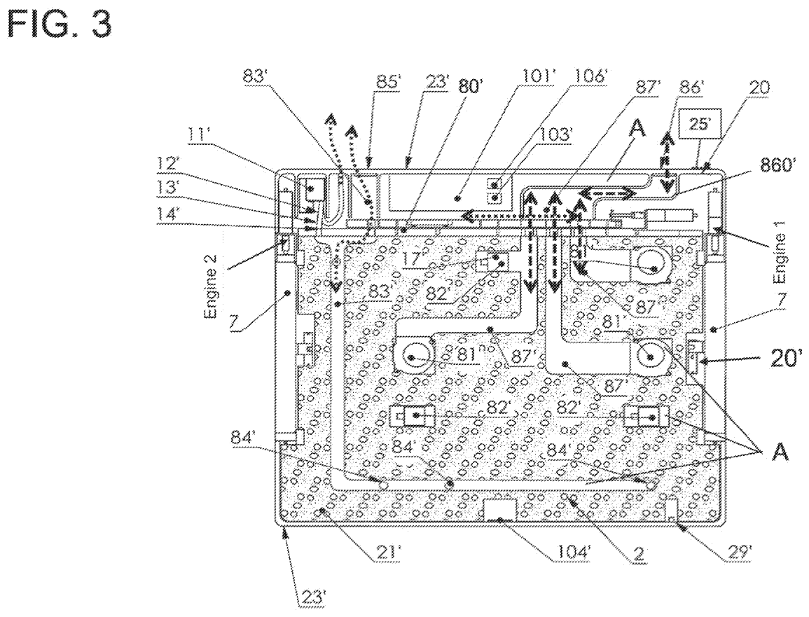

In the core layer 21′, there are provided recesses A in which the electric equipment such as evacuation means and dehumidifying means are arranged. Also motors and other components can partially be built in the recesses A, as shown in a better way in FIG. 3.

In order to achieve a lid 2 as dense as possible, preferably all of the components should be mounted within the lid 2 such that such a lid 2 can also be simply combined with existing drawers 3, by which vacuum drawer devices 0 can be made of existing drawer carcasses 9, a drawer 3 and a lid 2.

The core layer 21′ can be made of plastic hard foam or of a honeycomb-like plastic structure or a solid plastic layer, wherein the required recesses A have to be arranged. Channels and recesses A can be cut out of the material of the core layer 21′.

At the circuit board 20′, at least on one side there are arranged conductive tracks at which the electric consumers are connected. Contacting the components or, respectively, the components to be controlled by the controller and the controller of the circuit board 20′ is simple and not complicated. The circuit board 20′ is part of the sandwich-like lid 2 and is preferably built oriented in such way that the conductive tracks lead into the direction of the drawer interior R. There is no messy cabling within the lid 2 which continues outside of the lid 2 in the drawer carcass 9. Producing the lid 2 is simplified and the error rate when performing the lifting movement of the lid 2 is minimized.

In order to further increase the stability qualities of the lid 2, a bottom cover layer 22″ having the same qualities as the upper cover layer 22′ can be used as part of the sandwich structure. That bottom cover layer 22″ is fixed at the circuit board 20′ on the drawer interior side. For the air to be able to flow through the sandwich-like lid 2, wholes have to be arranged in the circuit board 20′ and the optional cover layer 22″ such that the drawer interior R or, respectively, the interior of the containers 14 can be pumped off.

In order to increase the evacuation qualities or, respectively, the sealing qualities of the lid 2, a layer of sealing profiles 31′ is arranged on the drawer interior side, by which the sealing against the edges of the containers 14 or, respectively, the seal fittings 15 is improved. Due to hygienic reasons, the seal fittings 31′ are releasably fixed and therefore can be removed when cleaning.

In a further embodiment with or without bottom cover layer 22′ and/or seal fittings 31′, a seal retainer 32′ and a layer of air filter material 38′ is attached at the drawer side face of the lid 2.

In a top view onto the lid 2 when the upper cover layer 22′ is removed, a lid frame 23′ can be identified in which the individual layers of the sandwich structure are kept. In addition to the increased stabilization, the lid frame 23′ is advantageous. In this case, the core layer 21′ can be identified which has recesses A. Underneath the core layer 21′, the circuit board 20′ is visible, wherein the organization of the layers of the lid 2 can also be different, for example without a circuit board 20′. A power connection device 20 is indicated at the upper lid frame 23′ which can be operatively connected with the connecting plug 25′.

In this case, the lifting means 7 comprise two motors and one mechanism which are arranged in the edge area of the lid 2 or, respectively, the core layer 21′. The lifting means 7, too, are connected to the controller but can for example also have only one motor and one other mechanism. In this case, the controller is designed as control board 101′ which is also placed in the lid 2.

As evacuation means, a pump 11′, an air hose 12′ for the pump 11′ and a plug 14′ are arranged in this case. In addition, a non-return valve 13′ is advantageous such that the evacuated volume is not ventilated undesirably. These components 11′, 12′, 13′, 14′, controlled by the control board 101′ are detected as evacuation means and in this case are arranged on the side of the core layer 21′ opposite to the later front panel 17 or, respectively, the operating button 104′.

Evacuating the drawer interior R or, respectively, the containers 14 can be done by means of the pump 11′ running through evacuation channels 83′ and wholes 84′ in the lid 2. By using a controllable valve 80′, an evacuation of the drawer interiors R or, respectively, the containers 14 can be carried out by the controller in an automated manner, when the at least one evacuation channel 83′ is opened and closed in a controlled manner using the valve 80′. As soon as the valve 80′ is open, the air can be pumped out by means of the pump 11′. The evacuation channels 83′, the wholes 84′ and the controllable valve 80′ are also part of the evacuation means.

For the evacuation the air pressure or, respectively, the status of the negative pressure in the drawer interior R or the containers 14 should be communicated to the controller. For this, at least one pressure sensor 17′ is arranged in an evacuation channel 83′ or, respectively, in a recess A that can be closed using valve 80′. This way, the controller can be programmed for a threshold of the negative pressure and if the pressure sensor 17′ reports a shortfall, the controller will be able to activate the valve 80′ and the pump 11′ accordingly. Air, as marked by the dotted arrow, is pumped out of the evacuation channel 83′ when the valve 80′ is in the evacuation position.

In the back area of the lid 2 opposing the front panel 17, there are arranged an air outlet opening 85′, the control board 101′, an acceleration sensor 103′ and a Bluetooth module 106′, that is to say a radio transmission unit according to Bluetooth standard. In that case, also other radio transmission protocols would be possible to program or, respectively, to manipulate the controller or, respectively, the control board 101′ of the vacuum drawer device 0. By way of the air outlet opening 85′, air that has been pumped out using the pump 11′ is removed from the lid 2. Preferably, the air outlet opening 85′ has an air filter that is exchangeable. In this case, the control board 101′ represents the controlling of the lifting means, evacuation means and dehumidifying means.

In order to dehumidify the drawer interior R and/or the containers 14, the lid 2 in this case has dehumidifying means. Said means are arranged in the lid 2, preferably in the recesses A in the core layer 21′, and are at least partially electrically connected with the controller.

Through at least one air inlet opening 86′, preferably having an air filter, fresh air from outside the lid 2 can flow limited by optional air inlet channel walls 860′ through dehumidifying channels 87′. Into the drawer interior R or, respectively, containers 14 through at least one exhaust air opening 33′ in the lid 2, when the valve 80′ is open. Air can be discharged from the drawer interior R or, respectively the containers 14 through the exhaust air opening 33′, the at least one dehumidifying channel 87′, by means of a ventilator 81 finally through the air outlet opening 85′ and/or the air inlet opening 86.

Actuation of the valve 80′, in this case is also carried out in an automated manner by the controller. The at least one dehumidifying channel 87′ communicates with the drawer interior R or, respectively, the container interior such that upon arrangement of at least one humidity sensor 82′, the latest humidity can be measured and transmitted to the controller. The at least one humidity sensor 82′, in this case, is arranged in the dehumidifying channel 87′ or in a recess communicating with the drawer interior R or, respectively one of the containers 14. Preferably, side walls 860′ are arranged along the dehumidifying channels 87′ and the openings 85′, 86′.

The humidifying process works by means of at least one ventilator 81′ which is arranged in a recess A in along the path of the at least one dehumidifying channel 87′. The ventilator 81′ takes care of the suction and distribution of fresh air in the drawer interior R and the containers 14 when the lid 2 is closed, by which water/steam can be transported away from the food stored.

### Monitoring Method and Dehumidification

For monitoring the drawer interior R when the lid 2 is closed, the following steps are necessary. The controller/control board 101′ is programmed in such way that the relative humidity in the air is measured constantly at timed intervals with the at least one humidity sensor 82′ which communicates with the drawer interior R or, respectively, the container interior by way of the dehumidifying channel 87′.

If the relative humidity rF in the dehumidifying channel 87′ in the drawer interior R or, respectively, in the container interior exceeds the upper threshold of 80%, the controller opens the valve 80′ such that fresh air through the air inlet opening 86′ is distributed on the inside for purging by means of at least one ventilator 81′. When circulating the fresh air through the ventilator 81′, the air supplied absorbs humidity from the surfaces of the food such that humidity is led out.

The at least one humidity sensor 82′ keeps measuring at timed intervals and when reaching a relative humidity of lower than 60% as lower threshold, tells the controller to close the at least one valve 80′ and to stop the at least one ventilator 81′ such that subsequently the controller switches back into the monitoring mode.

In order to continue to protect the food permanently, the evacuation, too, should be initiated. Accordingly, the evacuation means are initiated thereafter, if necessary, the valve 80′ is brought into the evacuation position and the drawer interior R or, respectively, the containers are set to a desired negative pressure. As soon as that desired negative pressure is achieved, the valve 80′ is closed and the pump 11′ switched off. Thereafter, the controller switches back to the monitoring mode, wherein the humidity is monitored by means of the at least one humidity sensor 82′ and as an option also the negative pressure is monitored with the at least one pressure sensor 17′.

It would also be possible to automatically initiate the dehumidifying process by schedule without measuring the relative humidity in advance. Then, however, the energy consumption increases accordingly, as possibly dehumidifying occurs without being necessary.

Also, when short falling a minimum negative pressure, measured by the at least one pressure sensor 17′, the controller activates itself in an automated manner and evacuates the drawer interior R or, respectively, the containers 14 once again.

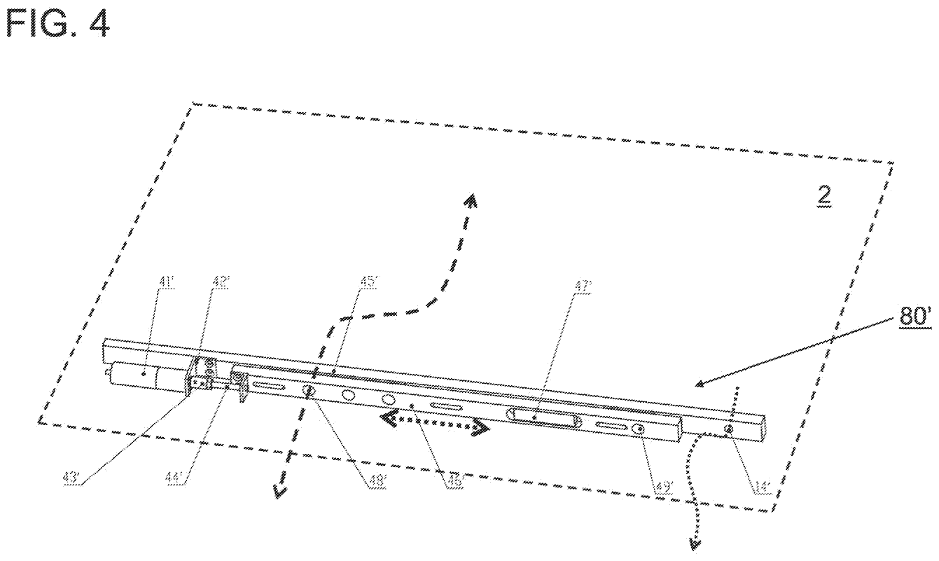

FIG. 4 shows a preferred possibility as to how a valve 80′ can be designed. In this case, a linearly operated valve 80′ is provided which is driven by a gear engine 41′. At a base profile 45′, the gear engine 41′ is fixed by way of an engine mount 42′. By way of a shaft clutch 43′, a spindle 44′ can be actuated which is operatively connected with a variable profile 46′. By this, the variable profile 46′ can be moved linearly relative to the base profile 45′, as indicated with the double arrow.

In the base profile 45′, openings are provided which can be sealed or, respectively released with the variable profile 46′. The variable profile 46′ can be shifted relative to the base profile 45′ and linearly along the base profile 45′. At least one air outlet opening 48′ and at least one air inlet opening 49′ are cut out in the variable profile 46′. Depending on the relative position of the variable profile 46′ to the base profile 45′, air can flow through and can be led into the dehumidifying channel 87′ and/or the evacuation channel 83′ during later operation.

For the controller to be able to read the status of the valve 80′ or, respectively, the position of the variable profile 46′, in this case a slide potentiometer 47′ is arranged, the respective electric resistance of which permits conclusions regarding the position of the variable profile 46′.

As an option, also an opening 14′ for connecting the pump 11′ and the evacuation channel 83′ is arranged in the base profile 45′ in this case. Evacuation can, however, also be carried out controlled by a further valve.

The linear valve 80′ can be specifically opened and closed by the controller such that carrying out the dehumidifying process is no problem. The linear valve 80′, too, is arranged quite dense within the lid 2. The linear valve 80′ can be a part of the multi-layered lid 2.

On the bottom side of the lid 2 or, respectively, the cover layer 22′ directed to the drawer interior R, seal retainers 32′ and a layer of air filter material 38′ are applied. The seal profiles 31′ surround individual sections in which the layer of the seal retainers 32′ can be recognized which cover the air filter material 38′, wherein the containers 14 underneath these sections come to rest later. In each of these areas, the exhaust air opening 33′ is arranged at the height of the ventilator 81′ that is not illustrated. The opening 35′ for the humidity sensor 82′ is also arranged in each area. Just like in each case the supply air opening 34′, through which every sealing profile 31′ or, respectively, the drawer interior can be ventilated by way of the controller.

The sealing means consisting of sealing profiles 31′, the seal retainers 32′ and the layer of air filter material 38′ are configured in such way that they can be interchangeably arranged at the lid 2. The sealing means can be entirely removed from the lid 2, for example for cleaning.

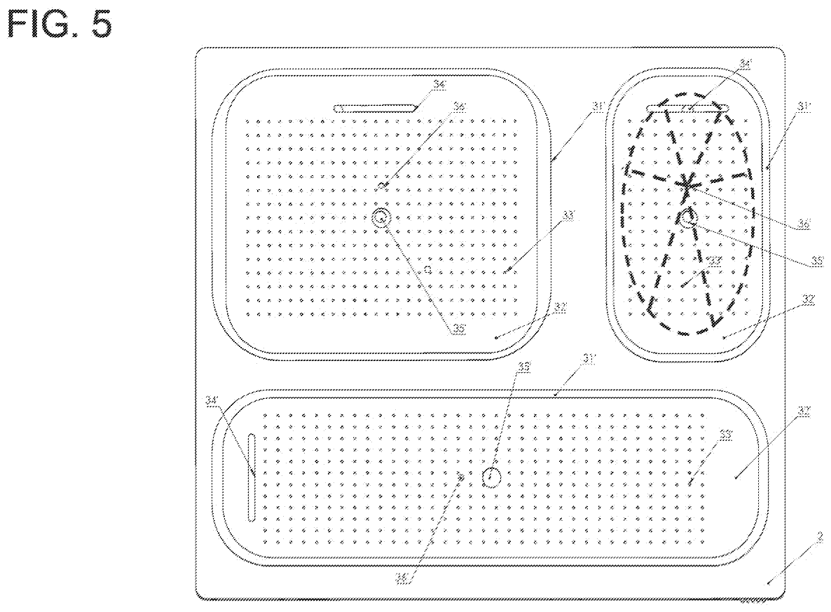

In order to further increase the shelf life of the openly stored food in the containers 14 or, respectively, the drawer interior R, the drawer interior R should be illuminated with blue light within the wavelength range of 450 nm to 470 nm, preferably with 460 nm. For this, at least one corresponding light source 36′ connected to the controller is arranged in a radiating manner at the bottom side of the lid 2 in the drawer interior or, respectively, the containers. In this case, the light source 36′ sends out its light through an opening in the sealing means having a maximum possible light cone in a, if possible, planar fashion. One example of a light cone is indicated in broken lines in FIG. 5. The negative pressure can be achieved with exhaust air openings 33′ and the dehumidification with supply air openings 34′.

It is advantageous that the arrangement of all components in the lid 2 or, respectively, in the recesses in at least one cover layer, in particular in the core layer 21′, is dense. The components preferably project at least partially into the recesses A or out of them. The entire lid 2 whether having a sandwich structure or not has to be airtight in such way that the lid 2 can sufficiently seal the drawer interior R from the outside air. The fact that the controller has to be sufficiently supplied with power, is self-evident for a person skilled in the art. Even if the controller is in the form of a control board 101′, the power supply has to be ensured.

1. A method for monitoring a drawer interior of a drawer of a vacuum drawer device when the lid is supported by the drawer in an airtight and closed manner, wherein the lid is operatively connected with a controller and electric evacuation means and/or dehumidifying means which can be operated by the controller in an automated manner
the method including:
periodic measurement of the relative humidity with at least one humidity sensor that is arranged in the path of at least one dehumidifying channel in the lid or, respectively, the drawer interior,
comparison of the measured relative humidity with an upper threshold and as soon as the measured relative humidity is above the upper threshold,
opening of at least one valve and induction of at least one ventilator which is arranged in a recess or in the path of at least one dehumidifying channel in the lid, wherein fresh air is sucked through at least one air inlet opening, circulated and thereafter released again from the at least one dehumidifying channel and the drawer interior communicating therewith, as long
until the relative humidity reaches a lower threshold measured by the at least one humidity sensor, at which the at least one valve is closed, the at least one ventilator is stopped and the controller subsequently switches into the humidity monitoring mode.

2. The monitoring method according to claim 1, wherein after the closing of the at least one valve, the evacuation means are induced and the drawer interior is set to a desired negative pressure, wherein after achieving the desired negative pressure the controller turn off the evacuation means, too.

3. A lid for resting on a drawer of a vacuum drawer interior having lifting means, wherein the lid makes a sealing of a drawer interior to the drawer through suitable means in the lid possible, wherein the lid and the lifting means are operatively connected to a controller,
wherein
in the lid there are arranged dehumidifying means which comprise at least one controllable valve and one ventilator which are operatively connected with the controller, as well as an air outlet opening, an air inlet opening and a dehumidifying channel such that in timed intervals fresh air from outside the lid and the drawer interior can be supplied, circulated and, controlled by the at least one ventilator and the valve can be removed again from the drawer interior.

4. The lid according to claim 3, wherein the dehumidifying means have at least one humidity sensor which is operatively connected to the controller and permits the controlled measurement and monitoring of the humidity in the drawer interior or, respectively, in the dehumidifying channel or, respectively at the place of the ventilator.

5. The lid according to claim 3, wherein the dehumidifying means, in particular the valve is arranged in one or more recesses in a core layer of the lid having a sandwich structure.

6. The lid according to claim 3, wherein the controllable valve is configured as linear valve comprising a variable profile, which can be linearly moved relative to a base profile, and required openings at the base profile and at the variable profile are arranged such that differing openings are open or closed depending on the relative position of both profiles to each other.

7. The lid according to claim 6, wherein a slide potentiometer is arranged for determining the respective position of the variable profile relative to the base profile that is operatively connected to the controller.

8. The lid according to claim 6, wherein the valve or, respectively, the variable profile can be actuated by means of a gear engine, which is fixed by way of an engine mount at the base profile, via a shaft clutch and a spindle.

9. The lid according to claim 3, wherein the controller is arranged as control board in the lid, preferably in one or more recesses in a core layer of the lid having a sandwich structure.

10. The lid according to claim 3, wherein at last one light source is mechanically arranged at the or in the lid and electrically connected with the controller, which radiates blue light controlled by the controller to the drawer interior or, respectively, into the interior of a container in the drawer, said blue light having a wavelength of 460 nm (×/−10 nm).

11. A vacuum drawer device comprising a drawer that can be linearly moved into a sliding movement direction having at least one drawer interior with a controller and a lid according to claim 3.
